(19) United States
(12) Patent Application Publication
(10) Pub. No.: US 2009/0184288 A1
(43) Pub. Date: Jul. 23, 2009

(54) Flocculant and Method for Manufacturing the Same

(75) Inventors: Shinichiro WADA, Ogoori-shi (JP); Tatsuo Morimoto, Himeji-shi (JP); Ai Kuchibune, Himeji-shi (JP)

Correspondence Address: CROCKETT & CROCKETT, P.C., 26020 ACERO, SUITE 200, MISSION VIEJO, CA, 92691, US

(73) Assignee: Astec Co., Ltd.

(21) Appl. No.: 12/017,302

(22) Filed: Jan. 21, 2008

(51) Int. Cl. C01B 33/26

(52) U.S. Cl. 252/175

(57) ABSTRACT

A flocculant including, as a principal component, unit particles obtained by breaking down aggregates of mineral particles in a mineral raw material principally comprising fine particles of a hydrous aluminum silicate including soils or weathering products of rocks including volcanic eruptives

### FIELD OF THE INVENTION

The present invention relates to a flocculant and a method for manufacturing the flocculant. More particularly, the invention relates to a flocculant utilizing the self-flocculating property of unit particles per se made from a mineral raw material principally comprising fine particles of hydrous aluminum silicates including soils or weathering products of rocks (including volcanic eruptives).

### BACKGROUND OF THE INVENTION

Typical flocculants that have been used for water treatment include polyvalent metal salts, clusters of polyvalent metal hydroxides, polysilicate ions, complexes between polysilicate ions and clusters of polyvalent metal hydroxides, synthetic polymer compounds and the like.

All of the above are chemically synthetic, and, for example, polyvalent metal salts, clusters of polyvalent metal salt hydroxides, and synthetic polymer compounds are often physiologically active themselves. Therefore, when used in large amounts, they may pose a risk of adversely affecting the environment by unreacted components of the flocculant remaining in treated water.

Also, when suspended matter in the water to be treated are particulate minerals including soils and deposits, aggregates formed by using any of polyvalent metal salts, clusters of polyvalent metal hydroxides, polysilicate ions, complexes between polysilicate ions and clusters of polyvalent metal hydroxides, synthetic polymer compounds and the like may, depending on the amount used, greatly differ in composition from the suspended matter. This may limit the treatment of and recycling of aggregated sediments as natural resources.

Moreover, flocculants made from carbonates, oxides, hydroxides and the like of alkaline earth metals, or those containing any of these materials as component(s) have low physiological activity themselves, but may be inconvenient in treatment or recycling because they increase the pH of treated water, and form alkaline aggregated sediments.

In order to compensate for these drawbacks, Japanese Unexamined Patent Application Publication No. 2002-136978 discloses a flocculant made from a weathering product of a volcanic ash soil and/or a weathered pumice. This flocculant is made from a weathering product of a volcanic ash soil and/or a weathered pumice, and therefore, has little adverse effect on the environment even if it remains in treated water, and facilitates the treatment and recycling of aggregated sediments.

The technique described in Japanese Unexamined Patent Application Publication No. 2002-136978 is such that the surface area of a weathering product of a volcanic ash soil and/or weathered pumice is increased by grinding to make the charged region greater. This causes the zeta potential of suspended matter in the water to be treated to be neutralized to the range of ±10 mv. Owing to this neutralization, the attractive force between particles becomes stronger than the repulsion between surface charges, and the particles bind to each other. That is to say, a ground powder is used to neutralize the zeta potential of suspended particles.

With this technique of Japanese Unexamined Patent Application Publication No. 2002-136978, however, it is difficult to reduce the particle size to submicron by grinding, and there is a limit to the extent that the reaction surface area can be increased. As a result, it is necessary to add a large amount of the flocculant for charge neutralization.

Moreover, the mineral particles of the size of silt or sand contained in a raw material, such as quartz, feldspar, and volcanic glass, are made fine by grinding, and are added to the water to be treated as new suspended particles, i.e., suspended mater, because the structure of the hydrous aluminum silicate is destroyed, and therefore, aluminum easily dissolves as ions.

Furthermore, because the mineral particles are ground and used as a powder, they lack practicality in that it is difficult to produce such a powder in large amounts in advance. That is to say, if the powder is produced in large amounts and stored before use, it solidifies under a humid environment, and needs to be re-powdered again at the time of use, which can be troublesome and lacks practicality.

### SUMMARY OF THE INVENTION

It is accordingly an object of the invention to provide a fluid flocculant that exhibits an excellent flocculation effect, while utilizing the properties of a mineral raw material principally comprising fine particles of hydrous aluminum silicates including soils or weathering products of rocks (including volcanic eruptives), and a method for manufacturing the same.

Other objects of the invention will become apparent from the following description.

The aforementioned object of the invention can be achieved by the inventions summarized below.

In accordance with one aspect of the invention, there is provided a flocculant comprising, as a principal component, unit particles obtained by breaking down aggregates of mineral particles in a mineral raw material principally comprising fine particles of hydrous aluminum silicates including soils or weathering products of rocks including volcanic eruptives; the hydrous aluminum silicate in the unit particles retaining a structure thereof; the unit particles being present in water; and the unit particles exhibiting a self-flocculating property.

In the invention defined above, the hydrous aluminum silicate in the unit particles retains its structure, so that the flocculant can exhibit a maximal flocculation effect inherent in the flocculant raw material, and therefore, the amount used may only be very small.

The unit particles may be dispersed or loosely associated with one another in the water. In this case, the flocculant is highly reactive and can instantaneously exhibit a flocculation effect.

The flocculant may further comprise a pH adjuster so that the unit particles remain dispersed or loosely associated with one another in the water. In this case, the flocculant can be stably stored for a long period while maintaining its quality.

The pH or the concentration of a concomitant salt may be adjusted so that the unit particles dispersed or loosely associated with one another exhibit a self-flocculating property. In this case, because the unit particles dispersed or loosely associated with one another exhibit a self-flocculating property, suspended particles flocculate by adhering to, or being incorporated into, aggregates of the self-flocculated unit particles, and sediment, without being affected by the charge of the suspended particles. Moreover, even if the flocculant is added in an excessive amount, unreacted components of the flocculant do not remain in treated water.

In accordance with another aspect of the invention, there is provided a method for manufacturing a flocculant, comprising the steps of collecting a mineral raw material principally comprising hydrous aluminum silicates including soils or weathering products of rocks including volcanic eruptives, and sorting the mineral raw material; and obtaining unit particles by breaking down aggregates of mineral particles in the mineral raw material using an agitation, vibration or shaking process, with the mineral raw material being admixed with water in a dispersion container; the step of obtaining the unit particles comprising employing a process selected from the group consisting of agitation, vibration, shaking processes, and a combination thereof, to such an extent that a structure of the hydrous aluminum silicate in the unit particles is not destroyed.

In the invention defined above, the step of obtaining unit particles comprises employing a process selected from agitation, vibration, shaking processes, and a combination thereof, to such an extent that the structure of the hydrous aluminum silicate in the unit particles is not destroyed. Therefore, unlike conventional grinding processes, fine mineral particles of the size of silt or sand contained in the raw material are not made finer and are not added into the water to be treated as new suspended particles.

The method may further comprise adding a pH adjuster so that the unit particles remain dispersed or loosely associated with one another in the water. In this case, the flocculant can maintain flocculation stability for a long period.

The pH or the concentration of a concomitant salt may be adjusted so that the unit particles dispersed or loosely associated with one another exhibit a self-flocculating property. This ensures the self-flocculating property of the flocculant, thereby achieving stable flocculation and sedimentation of suspended particles.

### BRIEF DESCRIPTION OF THE DRAWINGS

FIG. 1 is the result of Water Quality Measurement (turbidity).

FIG. 2 is the result of Water Quality Measurement (temperature).

FIG. 3 is the result of Water Quality Measurement (electric conductivity).

FIG. 4 is the result of Water Quality Measurement (DO).

FIG. 5 is the result of Water Quality Measurement (pH).

FIG. 6 is indicated top liquid cloudiness degree.

FIG. 7 is a transmission electron microscope image.

FIG. 8 is a X-ray diffraction pattern.

FIG. 9 show the states of kaolinite.

### DETAILED DESCRIPTION OF THE PREFERRED EMBODIMENTS

Embodiments of the present invention will hereinafter be described.

In the method for manufacturing a flocculant according to the invention, the first step comprises collecting a mineral raw material principally comprising fine particles of hydrous aluminum silicates including soils or weathering products of rocks (including volcanic eruptives), and sorting the mineral raw material.

The principal raw material for use in the flocculant of the invention may be any mineral raw material principally comprising fine particles of hydrous aluminum silicates including soils or weathering products of rocks (including volcanic eruptives), such as, for example, red and yellow soils, red soils, andosols or weathering products of basalt, volcanic ash, or pumice.

Note that materials containing, for the most part, pebbles that may be inconvenient for water treatment are not preferable. Also, in the case where the organic matter content of treated water is legally regulated, those with high humic substance content is not preferable.

The second step comprises obtaining unit particles by breaking down aggregates of mineral particles in the mineral raw material using an agitation, vibration or shaking process, with the mineral raw material being admixed with water in a dispersion container; wherein the step of obtaining unit particles comprises employing a process selected from the group consisting of agitation, vibration, shaking processes, and a combination thereof, to such an extent that a structure of the hydrous aluminum silicate in the unit particles is not destroyed.

The soil or weathering products of rocks (including volcanic eruptives) collected may contain firm aggregates of mineral particles, or loose aggregates of mineral particles.

Depending on the extent of aggregation, a process may be used selected from the group consisting of agitation, vibration, shaking processes, and a combination thereof.

Examples of agitation processes include those using a stirrer, an impeller, an underwater pump, and an underwater mixer; examples of vibration processes include those using a high-frequency vibrator and sonic waves; and examples of shaking processes include reciprocating shaking and rotational shaking.

Mineral fine particles contained in soils or weathering products of rocks are principally composed of a hydrous aluminum silicate, and the structure of these mineral fine particles is easily destroyed by mechanical grinding. This results in problems such as easy dissolution of aluminum as ions. For this reason, it is not preferable to mechanically grind the soils or weathering products of rocks used as a raw material.

By employing the method of the invention described above, unlike conventional grinding processes, unit particles can be obtained by breaking down aggregates of mineral particles in a raw material, without destroying the structure of the hydrous aluminum silicates. Moreover, the mineral particles of the size of silt or sand contained in the raw materials are not made finer and added into the water to be treated as new suspended particles.

The unit particles are obtained according to the above-described dispersion process in water, and the flocculant of the invention is obtained in which the resulting unit particles are dispersed or loosely associated with one another in water.

Although the amount of water used is not particularly limited, it is determined in consideration of the specifications of the apparatus used for injecting water, transport cost of the manufactured flocculant, and the like.

Using the above-described process, the unit particles are dispersed in water without addition of any additives. This is basically considered to be due to charge repulsion.

This state of dispersion may deteriorate with the passage of time, in which case a pH adjuster is preferably added to maintain the dispersion of the unit particles in water.

The unit particles obtained according to the invention have a feature of exhibiting a self-flocculating property. The pH or the concentration of the concomitant salt may also be adjusted so that the unit particles exhibit a self-flocculating property.

As used in the specification, the term “self-flocculating property” means that the flocculant self-flocculates when added to water free of suspended particles (for example, water obtained by filtering the water to be treated using a membrane filter).

The flocculant of the invention does not exclude the addition of inactive materials for controlling its properties, other types of flocculants, and the like.

A supplementary explanation of the basic principals of the present invention is given next.

The present inventors studied the phenomena of dispersion and flocculation of fine particles contained in soils or weathering products of rocks (including volcanic eruptives) found in the natural environments, based on their findings concerning the flocculation mechanism of fine particles suspended in water.

As a result, the inventors found that when aggregates of mineral fine particles contained in soils or weathering products of rock (including volcanic eruptives) are broken down so that the mineral fine particles are dispersed or loosely associated with one another as unit particles, the resulting unit particles can function as a flocculant when added to the water to be treated, irrespective of the type of mineral component of the flocculant, provided that the unit particles flocculate by themselves (self-flocculate), or are made to exhibit a self-flocculating property by adjusting the pH or the concentration of the concomitant salt thereof.

Moreover, the inventors examined the function, as a flocculant, of the unit particles obtained by breaking down aggregates of particles in soils or weathering products of rocks (including volcanic eruptives), using a technique of colloid science. As a result, the inventors assumed that an important mechanism is that when mineral fine particles contained in soils or weathering products of rocks (including volcanic eruptives) exhibit a self-flocculating property in the water to be treated excluding the suspended particles, they physically incorporate therein suspended particles in the water to be treated to form flocs.

In addition, it was clarified that when the sign of the zeta potential of mineral fine particles contained in soils or weathering products of rocks (including volcanic eruptives) is opposite to that of suspended particles in the water to be treated, flocculation can be promoted via electrostatic interaction between the two particles.

As described in Japanese Unexamined Patent Application Publication No. 2002-136978, the neutralization of the surface charge via electrostatic interaction between suspended particles had been regarded to be the most important as a flocculation mechanism of different types of colloidal particles.

However, it was also found that a flocculant in accordance with the invention which is prepared by, for example, breaking down aggregates of mineral particles contained in a soil principally composed of kaolin minerals, and adjusting the pH to about 4.5, and which contains particles with a negative zeta potential, can function as a flocculant in turbid water containing suspended matter principally composed of illite and having the same negative zeta potential.

For this reason, it is assumed that an important mechanism is that when mineral fine particles contained in soils or weathering products of rocks (including volcanic eruptives) flocculate in the water to be treated, they physically incorporate therein suspended particles in the water to be treated to form flocs.

In summary, the flocculant of the invention can be prepared by obtaining unit particles by breaking down aggregates of mineral fine particles contained in soils or weathered rocks (including volcanic eruptives) to an allowable extent; the unit particles being dispersed or loosely associated with one another in water; and the mineral fine particles of the flocculant self-flocculating when added into the water to be treated.

In the invention, when the flocculant exhibits a self-flocculating property without adjusting the pH or the concentration of the concomitant salt thereof, such an adjustment is not necessary.

When the net surface charge of suspended matter in the water to be treated is known, it is advantageous that the flocculant is made alkaline with a pH adjuster if the net surface charge is positive, and to make the flocculant acidic if the net surface charge is negative, in order to promote flocculation.

Note, however, that the pH must be within a range such that the flocculant self-flocculates when added into the water to be treated. The method for adding the pH adjuster for that purpose is not particularly limited. While the type of the pH adjuster is not also limited, it is preferred to select those suitable for the purpose of treating water, meeting the quality standards of treated water, and the like. For example, when the treated water is used for drinking, or discharged into the river or sewage, the use of ammonia water for alkalizing the flocculant should be avoided.

Moreover, the pH of the flocculant, as measured by using a pH test paper, a pH meter or the like, is preferably such that iron, aluminum, silicon or the like does not significantly dissolve by the dissolution of the component contained in soils or weathering products of rocks (including volcanic eruptives).

### EXAMPLES

The present invention will further be described below with reference to the Examples.

### Example 1

Preparation of the Flocculant According to the Invention

A weathering product of volcanic ash with an organic carbon content of 0.1%, which was collected in the Kumamoto prefecture, was air-dried and used as a raw material. A 200-g quantity of the raw material was placed in a 1-L vessel, and water was slowly added, while mixing it well with the raw material, to a total volume of 1 L. The pH was then adjusted to 4.5 by adding 2 mol/L of hydrochloric acid. The resulting mixture was processed using T-A 4280 Ultrasonic Generator, manufactured by Kaijo Corporation, at a power of 200 W and at an ultrasonic frequency of 19.5 kHz, for 30 minutes.

Flocculation Test Using the Prepared Flocculant

Using dam lake water suffering from long-term turbidity, flocculation and sedimentation tests were performed with a jar tester, so as to examine the relationship between the amount of the flocculant used in the sample turbid water or the agitation conditions (time and intensity) and the change in turbidity. The material that had caused this dam lake water to be turbid for a long period was known to be sericite.

Experimental Procedure

A 500-ml portion of the sample turbid water was poured into each 500-ml beaker, and the beakers were set in a jar tester (JMD-8S, manufactured by Miyamoto Riken Ind. Co., Ltd.). The impeller rotation speed was adjusted to a set condition, and a set amount of the flocculant was added to each beaker with a pipet. The jar tester was then operated, and agitation was performed at the set speed for a set period of time. After the operation had stopped, the mixture was allowed to stand, and after 30 seconds, 1, 3, 5, 10, or 30 minutes had passed, the turbid water within each beaker (at 1 cm under the water surface) was sampled with a pipet or the like, and the turbidity was measured using an integrating-sphere turbidimeter.

Experimental Results

1. Amount

Under the uniform conditions of a turbidity of 114 ppm, an impeller rotation speed of 60 rpm, and an agitation time of 10 minutes, the amount of the flocculant was varied to 14, 36, 74, 150, 300, 700, or 1,500 mg/L, and the change in turbidity was examined after allowing the sample turbid water to stand for 10 minutes.

The experimental results are shown in Table 1.

TABLE 1
<The change in turbidity by amount of the flocculant>

| | | | turbidity | | |
|---|---|---|---|---|---|
| | | | | 10 | The removal rate |
| the amount of the | | impeller rotation | before | miniutes | stand still 10 minutes |
| flocculant | agitation time | speed | addition | later | later |
| (mg/L) | (min) | (rpm) | (ppm) | | (%) |
| 14 | 10 | 60 | 114 | 61.3 | 46.2 |
| 36 | | | 114 | 20.5 | 82.0 |
| 74 | | | 114 | 17.0 | 85.1 |
| 150 | | | 114 | 4.8 | 95.8 |
| 300 | | | 114 | 1.1 | 99.0 |
| 700 | | | 114 | 0.5 | 99.6 |
| 1500 | | | 114 | 1.1 | 99.0 |

It can be seen from Table 1 that when the flocculant was added to the sample turbid water in an amount of 150 mg/L or more, the turbidity decreased to less than 10 ppm.

2. Impeller Rotation Speed

Under the uniform conditions of a turbidity of 114 to 117 ppm, an amount of the flocculant of 150 mg/L, and an agitation time of 10 minutes, the impeller rotation speed was varied to 30, 60, 120, or 170 rpm, and the change in turbidity was examined after allowing the sample turbid water to stand for 10 minutes.

The experimental results are shown in Table 2.

TABLE 2
<The change in turbidity by impeller rotation speed>

| | | | turbidity | | |
|---|---|---|---|---|---|
| | | | | 10 | The removal rate |
| the amount of the | | impeller rotation | before | miniutes | stand still 10 minutes |
| flocculant | agitation time | speed | addition | later | later |
| (mg/L) | (min) | (rpm) | (ppm) | | (%) |
| 150 | 10 | 30 | 117 | 9.8 | 91.8 |
| | | 60 | 114 | 4.8 | 95.8 |
| | | 120 | 117 | 1.2 | 99.0 |
| | | 170 | 117 | 1.1 | 99.1 |

It can be seen from Table 2 that, as the rotation speed increased, the turbidity of the supernatant after allowing the sample turbid water to stand for 10 minutes decreased; however, even in the case of agitation at a rotation speed as low as 30 rpm, the turbidity after 10 minutes decreased to 10 ppm.

3. Agitation Time

Under the uniform conditions of a turbidity of 120 ppm, an amount of the flocculant of 150 mg/L, and an impeller rotation speed of 60 rpm, the agitation time was varied to 20 seconds, 1, 3, 5, or 10 minutes, and the change in turbidity was examined after allowing the sample turbid water to stand for 10 minutes.

The experimental results are shown in Table 3.

TABLE 3
<The change in turbidity by agitation time>

| | | | | turbidity | | |
|---|---|---|---|---|---|---|
| | | | | | 10 | The removal rate |
| the amount of the | | | impeller rotation | before | miniutes | stand still 10 minutes |
| flocculant | | | speed | addition | later | later |
| (mg/L) | agitation time | | (rpm) | (ppm) | | (%) |
| 150 | 20 | sec. | 60 | 120 | 39.2 | 67.3 |
| | 1 | min. | | 120 | 28.6 | 76.2 |
| | 3 | min. | | 120 | 11.6 | 90.3 |
| | 5 | min. | | 120 | 4.6 | 96.2 |
| | 10 | min. | | 120 | 2.8 | 97.7 |

It can be seen from Table 3 that, as the agitation time increased, the turbidity of the supernatant after 10 minutes decreased, and the turbidity after allowing the mixture to stand for 10 minutes decreased to less than 10 ppm by agitation for 5 minutes or longer.

### Test on Influence of the Prepared Flocculant Upon Living Organisms

Experimental Procedure

Test living organisms (Japanese killifish, Oryzias latipes) were raised (acclimatized) in sample turbid water for a week, and then the flocculant was added to the sample water to cause suspended matter to flocculate and sediment. After keeping the living organisms under that environment for three weeks, they were examined for viability and symptoms. During the exposure period, changes in the water temperature, DO (dissolved oxygen concentration), and pH were checked.

A test fluid was prepared by adding 150 mg/L of the flocculant to 10 L of sample turbid water in a test vessel, and then agitating the mixture. Tests were carried out according to a semi-static method, in which the entire test fluid was replaced every seven days.

A test fluid for replacement was prepared, at the time of adding the flocculant (seven days after the start of the test), in the same manner as described above.

Moreover, after the addition of the flocculant, the test fluid was stirred up once a day to raise suspended matter.

The number of the test living organisms was 10/test area, and the amount of the test fluid was 10 L/test area. The Japanese killifish was fed an appropriate amount of brine shrimp (Artemia salina) larvae twice a day during the exposure period. Note that the test area where the flocculant of the invention was not added to de-chlorinated tap water was defined as a control area I, and the test area where the flocculant of the invention was not added to sample turbid water was defined as a control area II.

Experimental Results

The test results are shown in Tables 4 and 5.

TABLE 4
<The result of Test on Influence Upon Living Organisms(survival rate)>

| | A survival rate(%) | | | | | |
|---|---|---|---|---|---|---|
| | During an | | | | | |
| | acclimation period | | | | | |
| An examination | | | just after | After flocculant injection | | |
| section | 0 day | 7 day | injection | 7 day | 14 day | 21 day |
| Control area I | 100 | 100 | 100 | 100 | 100 | 100 |
| Control area II | 100 | 100 | 100 | 100 | 100 | 100 |
| The area treated by | 100 | 100 | 100 | 100 | 100 | 100 |
| the flocculant of this | | | | | | |
| invention | | | | | | |

TABLE 5
<The result of Test on Influence Upon Living Organisms(symtoms)>

| | A survival rate(%) | | | | | |
|---|---|---|---|---|---|---|
| | During an | | | | | |
| | acclimation period | | | | | |
| An examination | | | just after | After flocculant injection | | |
| section | 0 day | 7 day | injection | 7 day | 14 day | 21 day |
| Control area I | — | — | — | — | — | — |
| Control area II | — | — | — | — | — | — |
| The area treated by | — | — | — | — | — | — |
| the flocculant of this | | | | | | |
| invention | | | | | | |

— shows symptom was not observed

It is seen from Tables 4 and 5 that none of the test living organisms were sacrificed in any test area during the exposure period, with the survival rate being 100%. Also, in any of the area treated by the flocculant of the invention, control area I, and control area II, no symptoms were observed in the test living organisms.

These results confirmed that the flocculant exerts no influence upon living organisms.

On-Site Sedimentation Tests Using the Prepared Flocculant

Experimental Procedure

Tests for examining the effects of various types of flocculants were carried out near the intake of a reservoir suffering from long-term turbidity. Five test water tanks (12 m3) were installed near the intake, and 10 m3 of turbid water was pumped into each water tank using an underwater pump. Turbid water (raw water) before the addition of the flocculant was sampled, and then an appropriate amount of each flocculant was added to the turbid water. The mixture was then agitated for 10 minutes in an agitator (an underwater mixer). After the agitator stopped, and the turbid water was allowed to stand, changes over time in the qualities of water, such as turbidity, were examined. After the tests were completed, the treated water and the flocculated sediments were analyzed for harmful substances and the like, in order to examine the influence of each flocculant upon living organisms. The sedimentation tests were carried out for two weeks in two batches.

Table 6 shows a summary of the flocculants added to the tanks and the amounts used.

TABLE 6

| Water tank No. | | | | |
|---|---|---|---|---|
| 1 | 2 | 3 | 4 | 5 |

1st batch

| | | | | | |
|---|---|---|---|---|---|
| Flocculant | Control | A agent | A agent + PAC | B agent | C agent |
| (Coagulate) | | | | | |
| Summary of | — | The natural | Combination of | The water | The carbonate |
| flocculants | | mineral water | Agent and PAC | purifier which | mineral of the |
| | | treatment agent | | combined an | alkaline earth |
| | | which assumed | | inorganic cohesi | metals |
| | | Lime Magnesia | | acchellfish fossil | |
| | | calcium | | | |
| | | hydraride silicate | | | |
| | | the sulyect | | | |
| Property | — | White powder | White powder | White powder | White powder |
| Amount of | — | 10 | 50200 | 150 | 100 |
| addition(mg/L) | | | | | |
| Stiring time(min.) | 10 | 10 | 10 | 10 | 10 |

2nd batch

| | | | | | |
|---|---|---|---|---|---|
| Flocculant | Control | A agent | B agent | PAC | This invention |
| (Coagulate) | | | | | |
| Summary of | — | The natural | The water | Poly aluminum | The flocculant |
| flocculants | | mineral water | purifier which | chloride; | based on |
| | | treatment agent | combined an | Representative | volcanic ashen |
| | | which assumed | inorganic cohesi | inorganic | geest and water |
| | | Lime Magnesia | acchellfish fossil | flocculant | |
| | | calcium | | | |
| | | hydraride silicate | | | |
| | | the sulyect | | | |
| Property | — | White powder | White powder | Colorless liquid | Brown liquid |
| Amount of | — | 50 | 200 | 160 | 150 |
| addition(mg/L) | | | | | |
| Stiring time(min.) | 10 | 10 | 10 | 10 | 10 |

Experimental Results

1. Water-Quality Measurement

Before and after the addition of each flocculant, the qualities of water in the tank were measured using a multi-parameter water quality meter (YS1-6600). At the same time, water was sampled from each tank using a Hai-roto-type water sampler (which is used to sample water at a given depth of, e.g., rivers and lakes), and turbidity was measured using an integrating-sphere turbidimeter. Measurements were made at two points, i.e., the surface layer (at a depth of 0.2 m) and the bottom layer (at a depth of 1 m) of the water, and the five parameters of temperature, pH, turbidity, DO, and conductivity, were measured.

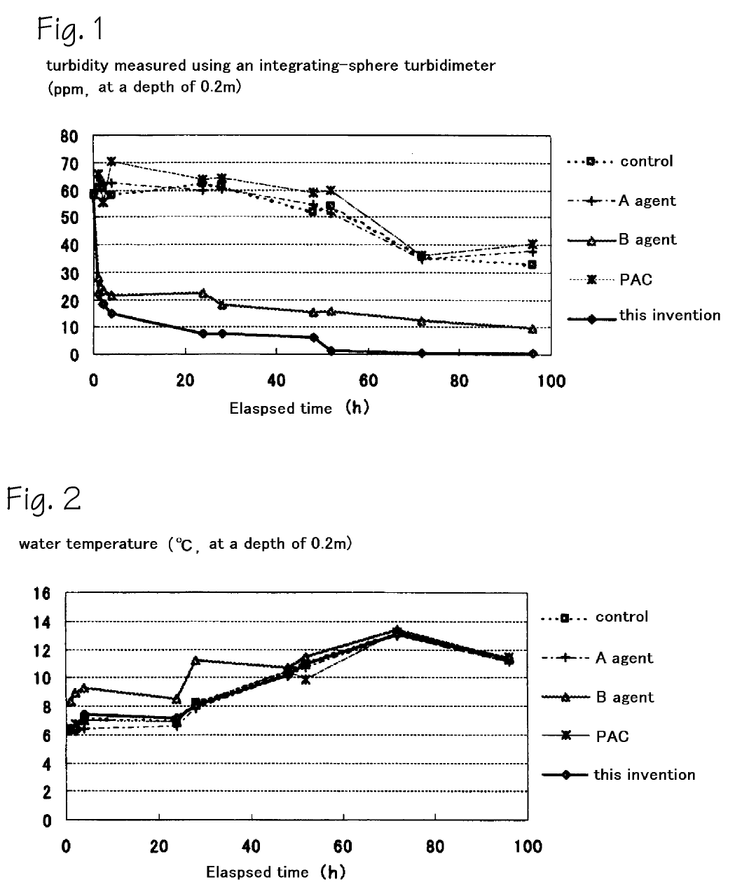

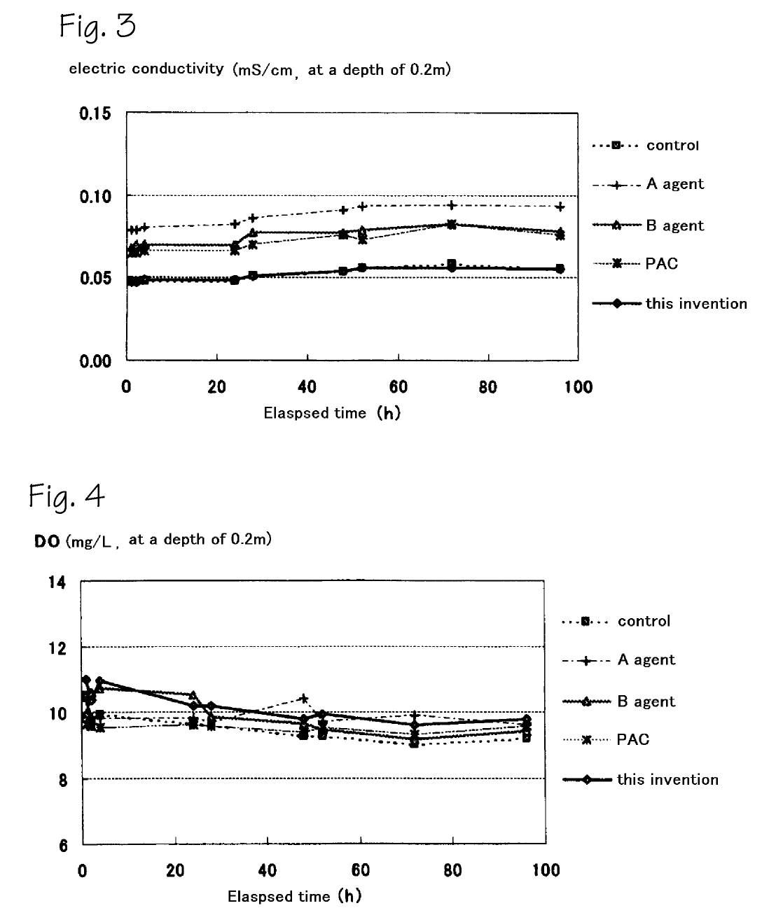

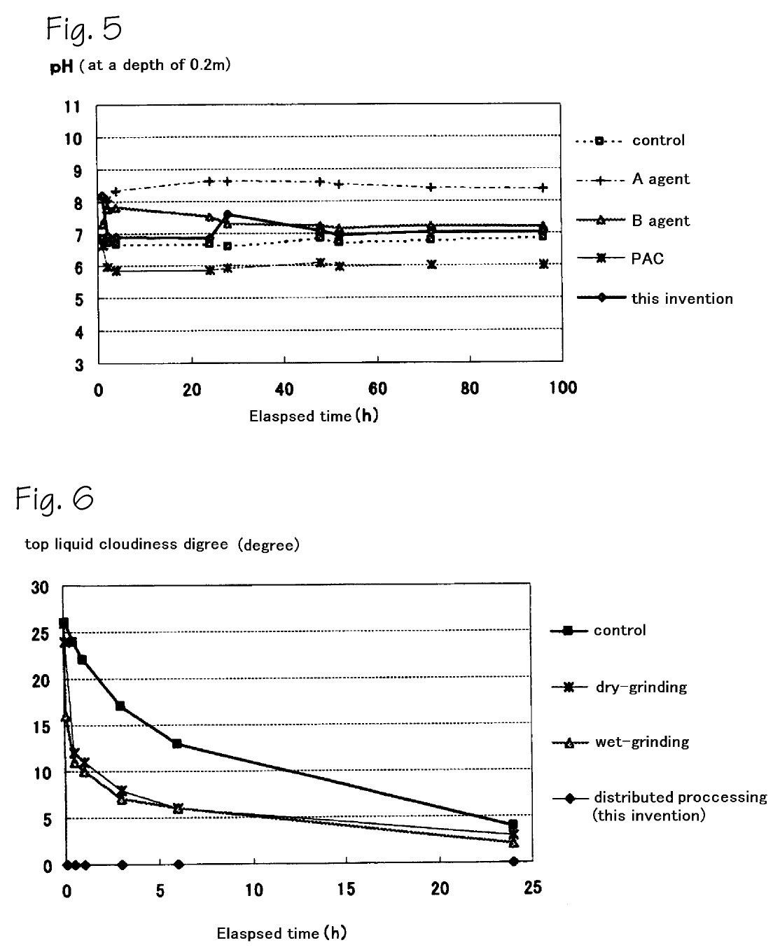

Tables 7 to 11 and FIGS. 1 to 5 show the results of measurements at the surface layer in the second batch.

TABLE 7
2nd batch The surface layer (at a depth of 0.2 m)

| | Flocculant (Coagulate) | | | | |
|---|---|---|---|---|---|
| | Control | A agent | B agent | PAC | This invention |
| Elapsed time (h) | Turbidity | | | | |
| 0 | 58.6 | 58.6 | 58.6 | 58.6 | 58.6 |
| 1 | 60.9 | 64.8 | 28.3 | 66.0 | 21.9 |
| 2 | 60.6 | 62.6 | 23.2 | 55.2 | 18.6 |
| 4 | 58.2 | 62.3 | 21.6 | 70.5 | 15.0 |
| 24 | 62.2 | 59.7 | 22.3 | 63.6 | 7.47 |
| 28 | 61.2 | 60.2 | 18.0 | 64.2 | 7.36 |
| 48 | 52.0 | 54.6 | 15.6 | 58.8 | 6.26 |
| 52 | 54.2 | 51.5 | 15.8 | 59.6 | 1.45 |
| 72 | 35.7 | 34.8 | 12.2 | 36.1 | 0.57 |
| 96 | 33.0 | 37.7 | 9.6 | 40.6 | 0.36 |

TABLE 8
2nd batch The surface layer (at a depth of 0.2 m)

| | Flocculant (Coagulate) | | | | |
|---|---|---|---|---|---|
| | Control | A agent | B agent | PAC | This invention |
| Elapsed time (h) | Temperature (° C.) | | | | |
| 0 | — | — | — | — | — |
| 1 | 6.4 | 6.3 | 8.3 | 6.4 | 6.4 |
| 2 | 6.3 | 6.2 | 8.9 | 6.8 | 6.4 |
| 4 | 7.2 | 6.4 | 9.3 | 7.0 | 7.4 |
| 24 | 7.0 | 6.5 | 8.5 | 6.9 | 7.2 |
| 28 | 8.3 | 7.8 | 11.2 | 8.2 | 8.0 |
| 48 | 10.4 | 10.1 | 10.7 | 10.5 | 10.2 |
| 52 | 11.1 | 10.7 | 11.5 | 9.9 | 11.0 |
| 72 | 13.2 | 12.9 | 13.4 | 13.2 | 13.1 |
| 96 | 11.2 | 11.1 | 11.3 | 11.4 | 11.3 |

TABLE 9
2nd batch The surface layer (at a depth of 0.2 m)

| | Flocculant (Coagulate) | | | | |
|---|---|---|---|---|---|
| | Control | A agent | B agent | PAC | This invention |
| Elapsed time (h) | Electric conductivity (mS/cm) | | | | |
| 0 | — | — | — | — | — |
| 1 | 0.047 | 0.079 | 0.068 | 0.065 | 0.047 |
| 2 | 0.047 | 0.079 | 0.070 | 0.065 | 0.047 |
| 4 | 0.048 | 0.080 | 0.070 | 0.066 | 0.049 |
| 24 | 0.048 | 0.082 | 0.070 | 0.066 | 0.049 |
| 28 | 0.051 | 0.086 | 0.077 | 0.070 | 0.051 |
| 48 | 0.054 | 0.091 | 0.077 | 0.076 | 0.054 |
| 52 | 0.056 | 0.093 | 0.079 | 0.073 | 0.056 |
| 72 | 0.058 | 0.094 | 0.082 | 0.082 | 0.056 |
| 96 | 0.055 | 0.093 | 0.078 | 0.076 | 0.055 |

TABLE 10
2nd batch The surface layer (at a depth of 0.2 m)

| | Flocculant (Coagulate) | | | | |
|---|---|---|---|---|---|
| | Control | A agent | B agent | PAC | This invention |
| Elapsed time (h) | DO (mg/L) | | | | |
| 0 | — | — | — | — | — |
| 1 | 10.5 | 10.4 | 10.0 | 9.6 | 11.0 |
| 2 | 9.7 | 9.9 | 10.6 | 9.6 | 10.4 |
| 4 | 9.9 | 9.8 | 10.7 | 9.5 | 10.9 |
| 24 | 9.7 | 9.8 | 10.5 | 9.6 | 10.2 |
| 28 | 9.6 | 9.7 | 9.9 | 9.6 | 10.2 |
| 48 | 9.3 | 10.4 | 9.6 | 9.4 | 9.8 |
| 52 | 9.3 | 9.7 | 9.5 | 9.5 | 9.9 |
| 72 | 9.0 | 9.9 | 9.2 | 9.3 | 9.6 |
| 96 | 9.2 | 9.6 | 9.4 | 9.6 | 9.8 |

TABLE 11
2nd batch The surface layer (at a depth of 0.2 m)

| | Flocculant (Coagulate) | | | | |
|---|---|---|---|---|---|
| | Control | A agent | B agent | PAC | This invention |
| Elapsed time (h) | pH | | | | |
| 0 | — | — | — | — | — |
| 1 | 6.9 | 8.1 | 7.3 | 6.6 | 8.2 |
| 2 | 6.7 | 8.0 | 7.8 | 6.0 | 6.9 |
| 4 | 6.7 | 8.3 | 7.8 | 5.9 | 6.9 |
| 24 | 6.7 | 8.6 | 7.5 | 5.9 | 6.9 |
| 28 | 6.6 | 8.6 | 7.3 | 5.9 | 7.6 |
| 48 | 6.9 | 8.6 | 7.2 | 6.1 | 7.1 |
| 52 | 6.7 | 8.5 | 7.2 | 6.0 | 6.9 |
| 72 | 6.8 | 8.4 | 7.2 | 6.0 | 7.0 |
| 96 | 6.9 | 8.4 | 7.2 | 6.0 | 7.0 |

It is seen from the results shown above that the flocculant of the invention exhibits a flocculation effect markedly superior to those of the other flocculants, in that a turbidity of 58.6 ppm before the addition of the flocculant decreased below half that level after an hour of allowing the turbid water to stand, below 10 ppm after a day, and below 1 ppm after four days. The conductivity and pH of the water were also very low.

2. Water-Quality Analyses

The qualities of the raw water were analyzed before the tests were started. Analyses were performed on the Environmental Standards for Protecting the Living Environments (six items), Environmental Standards Concerning the Human Health (26 items), and Standards for Industrial Water (five items, revised in 2000). Also after the tests were completed, treated water was sampled from each tank using a Van Dorn sampler, and the qualities of the water for these items were analyzed. A mixture containing an equal amount of the surface layer and the bottom layer was used as an analytical sample.

Table 12 shows part of the analytical results.

TABLE 12

| | | | Treated Water | | | | | | |
|---|---|---|---|---|---|---|---|---|---|
| | | Raw | | | A agent + | This | | | detection |
| | Unit | Water | Cont. | A agent | PAC | invention | Standards | | limit |
| pH | — (° C.) | 7.3 (19.1) | 7.1 (18.5) | 8.3 (18.1) | 7.5 (17.9) | 8.5 (17.4) | 6.5~8.5 | \textcircled{1} | — |
| BOD | mg/L | 0.3 | 1.4 | 1.8 | 0.9 | 1.6 | 2.0 | ″ | 0.2 |
| SS | mg/L | 68 | 56 | 46.8 | N.D. | N.D. | 25 | ″ | 1 |
| Zn | mg/L | 0.007 | 0.028 | 0.025 | 0.048 | 0.009 | 0.001 | \textcircled{3} | 0.001 |
| Anmonia-N | mg/L | 0.05 | 0.10 | 0.07 | 0.06 | N.D. | 0.2 | ″ | 0.05 |
| Cu | mg/L | 0.009 | 0.034 | 0.020 | 0.008 | N.D. | 0.001 | ″ | 0.001 |
| Al | mg/L | 0.86 | 0.86 | 0.79 | 0.17 | 0.009 | Must not be detected | ″ | 0.02 |
| Total-Mn | mg/L | 0.082 | 0.079 | 0.072 | 0.013 | 0.018 | 1 | ″ | 0.001 |
| Total-Fe | mg/L | 3.61 | 1.13 | 1.12 | 0.03 | 0.03 | 0.1 | ″ | 0.02 |
| Coliform group | MPN/100 ml | 330 | 70 | 23 | N.D. | N.D. | 1000 | \textcircled{1} | 2 |
| Total-N | mg/L | 0.42 | 0.43 | 0.40 | 0.42 | 0.35 | Must not be detected | — | 0.01 |
| Total-P | mg/L | 0.073 | 0.098 | 0.07 | N.D. | N.D. | Must not be detected | — | 0.005 |
| Cd | mg/L | N.D. | N.D. | N.D. | N.D. | N.D. | 0.01 | \textcircled{2} | 0.001 |
| CN | mg/L | N.D. | N.D. | N.D. | N.D. | N.D. | Must not be detected | ″ | 0.1 |
| Pb | mg/L | 0.003 | 0.014 | 0.011 | 0.002 | 0.002 | 0.01 | ″ | 0.001 |
| Cr (VI) | mg/L | N.D. | N.D. | N.D. | N.D. | N.D. | 0.05 | ″ | 0.005 |
| As | mg/L | 0.005 | 0.003 | 0.003 | N.D. | N.D. | 0.01 | ″ | 0.001 |
| T-Hg | mg/L | N.D. | N.D. | N.D. | N.D. | N.D. | 0.0005 | ″ | 0.00005 |
| R-Hg | mg/L | N.D. | N.D. | N.D. | N.D. | N.D. | Must not be detected | ″ | 0.0005 |
| PCB | mg/L | N.D. | N.D. | N.D. | N.D. | N.D. | Must not be detected | ″ | 0.0005 |
| trichloroethylene | mg/L | N.D. | N.D. | N.D. | N.D. | N.D. | 0.03 | ″ | 0.001 |
| tetrachloroethylene | mg/L | N.D. | N.D. | N.D. | N.D. | N.D. | 0.01 | ″ | 0.001 |
| dichloromethane | mg/L | N.D. | N.D. | N.D. | N.D. | N.D. | 0.02 | ″ | 0.001 |
| carbon tetrachloride | mg/L | N.D. | N.D. | N.D. | N.D. | N.D. | 0.002 | ″ | 0.0001 |
| 1,2-dichloro ethane | mg/L | N.D. | N.D. | N.D. | N.D. | N.D. | 0.004 | ″ | 0.0004 |
| 1,1-dichloro ethlene | mg/L | N.D. | N.D. | N.D. | N.D. | N.D. | 0.02 | ″ | 0.001 |
| cis-I,2-dichloro | mg/L | N.D. | N.D. | N.D. | N.D. | N.D. | 0.04 | ″ | 0.001 |
| 1.1.1-trichloro ethane | mg/L | N.D. | N.D. | N.D. | N.D. | N.D. | 1 | ″ | 0.001 |
| 1.1.2-trichloro ethane | mg/L | N.D. | N.D. | N.D. | N.D. | N.D. | 0.006 | ″ | 0.0006 |
| 1,3-dichloropropene | mg/L | N.D. | N.D. | N.D. | N.D. | N.D. | 0.002 | ″ | 0.0001 |
| thiuram | mg/L | N.D. | N.D. | N.D. | N.D. | N.D. | 0.006 | ″ | 0.0006 |
| simazine | mg/L | N.D. | N.D. | N.D. | N.D. | N.D. | 0.003 | ″ | 0.0003 |
| thiobencarb | mg/L | N.D. | N.D. | N.D. | N.D. | N.D. | 0.02 | ″ | 0.002 |
| benzene | mg/L | N.D. | N.D. | N.D. | N.D. | N.D. | 0.01 | ″ | 0.001 |
| Se | mg/L | N.D. | N.D. | N.D. | N.D. | N.D. | 0.01 | ″ | 0.001 |
| F | mg/L | N.D. | N.D. | N.D. | N.D. | N.D. | 0.8 | ″ | 0.08 |
| B | mg/L | N.D. | N.D. | N.D. | N.D. | N.D. | 1 | ″ | 0.1 |
| nitrate-N and nitrite-N | mg/L | 0.26 | 0.23 | 0.24 | 0.26 | 0.25 | 10 | ″ | 0.01 |

 Standards:
\textcircled{1} Enviromental standards about the maintenance of the living environment
\textcircled{2} Enviromental standards concerning the human health
\textcircled{3} Standards for industrial water

It can be seen from Table 12 above that when the qualities of water treated by each of the flocculants are compared with the environmental standards and the like, the water treated by the agent A exceeds the standards for six items, the water treated by the agent A and PAC exceeds the standards for three items, and the water treated by the flocculant of the invention exceeds the standards for two items.

However, from the facts that the raw water exceeds the standards for five items, and the control area exceeds the standards for six items, and that the water treated by the flocculant of the invention exhibits values equal to or lower than those of the control area, it is considered that the addition of the flocculant of the invention exerts substantially no adverse effects on the environment, such as deteriorations in water quality, increases in harmful components, and the like.

3. Analyses of Flocculated Sediments

After the tests were completed, flocculated sediments deposited on the bottom of each tank were sampled with a scoop or the like. The flocculated sediments were then subjected to tests for the dissolution of specific harmful substances as defined in the Measures Against Soil Contamination, and component analyses for aluminum and items of reservoir sediments to be monitored.

Tables 13 and 14 show part of the analytical results.

TABLE 13
<The result of elution examinations>

| | | | | | This | | detection |
|---|---|---|---|---|---|---|---|
| Parameter | Unit | Cont. | A agent | A agent + PAC | invention | standards | limit |
| Cu | mg/L | N.D. | N.D. | N.D. | N.D. | — | 0.01 |
| Al | mg/L | 0.25 | 0.16 | 1.04 | 0.09 | — | 0.02 |
| Cd | mg/L | N.D. | N.D. | N.D. | N.D. | 0.01 | 0.001 |
| total cyanide | mg/L | N.D. | N.D. | N.D. | N.D. | Must not be detected | 0.1 |
| Pb | mg/L | 0.002 | N.D. | N.D. | 0.001 | 0.01 | 0.001 |
| Cr (VI) | mg/L | N.D. | N.D. | N.D. | N.D. | 0.05 | 0.005 |
| As | mg/L | N.D. | N.D. | N.D. | N.D. | 0.01 | 0.01 |
| total mercury | mg/L | N.D. | N.D. | N.D. | N.D. | 0.0005 | 0.00005 |
| alkyl mercury | mg/L | N.D. | N.D. | N.D. | N.D. | Must not be detected | 0.005 |
| PCB | mg/L | N.D. | N.D. | N.D. | N.D. | Must not be detected | 0.005 |
| trichloroethylene | mg/L | N.D. | N.D. | N.D. | N.D. | Must not be detected | 0.001 |
| tetrachloroethylene | mg/L | N.D. | N.D. | N.D. | N.D. | Must not be detected | 0.001 |
| dichloromethane | mg/L | N.D. | N.D. | N.D. | N.D. | 0.02 | 0.001 |
| carbon tetrachloride | mg/L | N.D. | N.D. | N.D. | N.D. | 0.002 | 0.0001 |
| 1,2-dichloro ethane | mg/L | N.D. | N.D. | N.D. | N.D. | 0.004 | 0.0004 |
| 1,1-dichloro ethlene | mg/L | N.D. | N.D. | N.D. | N.D. | 0.02 | 0.001 |
| cis-I,2-dichloro ethylene | mg/L | N.D. | N.D. | N.D. | N.D. | 0.04 | 0.001 |
| 1.1.1-trichloro ethane | mg/L | N.D. | N.D. | N.D. | N.D. | 1 | 0.001 |
| 1.1.2-trichloro ethane | mg/L | N.D. | N.D. | N.D. | N.D. | 0.006 | 0.0006 |
| 1,3-dichloropropene | mg/L | N.D. | N.D. | N.D. | N.D. | 0.002 | 0.0001 |
| thiuram | mg/L | N.D. | N.D. | N.D. | N.D. | 0.006 | 0.006 |
| simazine | mg/L | N.D. | N.D. | N.D. | N.D. | 0.003 | 0.003 |
| thiobencarb | mg/L | N.D. | N.D. | N.D. | N.D. | 0.02 | 0.02 |
| benzene | mg/L | N.D. | N.D. | N.D. | N.D. | 0.01 | 0.001 |
| selenium | mg/L | N.D. | N.D. | N.D. | N.D. | 0.01 | 0.01 |
| fluorine | mg/L | N.D. | N.D. | N.D. | N.D. | 0.8 | 0.8 |
| boron | mg/L | N.D. | N.D. | N.D. | N.D. | 1 | 0.1 |
| organic phosphorus | mg/L | N.D. | N.D. | N.D. | N.D. | Must not be detected | 0.05 |

 The standard is an environmental standard about the pollution of the soil

TABLE 14
<The result of ingredient examinations>

| | | | | | This | | detection |
|---|---|---|---|---|---|---|---|
| Parameter | Unit | Cont. | A agent | A agent + PAC | invention | standards | limit |
| Ignition loss | % | 7.79 | 6.98 | 10.1 | 7.84 | — | 0.05 |
| T-C | % | 1.24 | 1.08 | 0.90 | 1.50 | — | 0.01 |
| T-N | mg/kg | 1900 | 1930 | 1380 | 1880 | — | 10 |
| T-P | mg/kg | 620 | 540 | 530 | 620 | — | 10 |
| Fe | % | 4.7 | 4.6 | 3.8 | 4.7 | — | 0.1 |
| Mn | % | 0.08 | 0.11 | 0.06 | 0.08 | — | 0.01 |
| Water content | % | 189 | 141 | 2050 | 116 | — | 0.05 |
| Al | % | 3.0 | 3.3 | 8.2 | 3.2 | — | 0.1 |
| Cu | mg/kg | 13.6 | 15.2 | 1.5 | 5.0 | 125 | 0.1 |
| As | mg/kg | N.D. | N.D. | N.D. | N.D. | 15 | 0.5 |

 The standard is an environmental standard about the pollution of the soil

It can be seen from Tables 13 and 14 above that although in the dissolution tests, lead was detected in the control area, and lead and fluorine were detected in the water treated by the flocculant of the invention, all of these values were below the environmental standard values, and were therefore insignificant.

Moreover, while aluminum was detected in the samples of water treated by all of the flocculants, the water treated by the agent A and PAC exhibits a value higher than that of the control area. The component analysis results show that the sediments for the agent A and PAC exhibit values higher than those of the control area and others with respect to ignition loss, moisture content, and aluminum.

### Example 2

In order to examine the effect of the dispersion process according to the invention, two types of flocculants were prepared according to grinding processes (comparative examples), and one type of flocculant was prepared according to a dispersion process (example of the invention), using, as a raw material, a sample obtained by air-drying a weathering product of volcanic ash with an organic carbon content of 0.1% collected in the Kumamoto Prefecture. Flocculation tests were performed on these flocculants.

Experimental Procedure

Three types of flocculants were prepared: a powdery sample prepared by grinding the raw material in a mortar for 10 minutes (dry-grinding process); a fluid sample prepared by adding, to the raw material in a mortar, water four times the amount of the raw material, and grinding the raw material in the water (wet-grinding process); and a fluid sample prepared using the dispersion process as described in Example 1 (dispersion process (the present invention)).

Dam lake water suffering from long-term turbidity was used as sample turbid water. A 500-ml portion of the sample turbid water was poured into each 500-ml beaker, and the beakers were set in a jar tester (JMD-3S, manufactured by Miyamoto Riken Ind. Co., Ltd.). The impeller rotation speed was set to 150 rpm, and each of the flocculants was added to the beakers in an amount of 200 mg/L. After 10 minutes, the impeller rotation speed was set to 50 rpm, and the sample turbid water was agitated at a low speed for 1 minute. After the operation had stopped, the mixture was allowed to stand, and after 3 minutes, 30 minutes, 1, 3, 6, or 24 hours had passed, the turbid water within the beakers (at 1 cm under the water surface) was sampled with a pipet or the like, and the turbidity was measured.

Experimental Results

Table 15 and FIG. 6 show the test results.

TABLE 15

| | | | | | dispersion process |
|---|---|---|---|---|---|
| | | | dry-grinding | wet-grinding | (the present |
| | | Control | process | process | invention) |
| Elapsed time | | Turbidity (degree) | | | |
| 0 | min. | 26 | 26 | 26 | 26 |
| 3 | min. | 26 | 24 | 16 | 0 |
| 30 | min. | 24 | 12 | 11 | 0 |
| 1 | hour | 22 | 11 | 10 | 0 |
| 3 | hour | 17 | 8 | 7 | 0 |
| 6 | hour | 13 | 6 | 6 | 0 |
| 24 | hour | 4 | 3 | 2 | 0 |

Table 15 above shows that the flocculant of the invention prepared using the dispersion process underwent a flocculation reaction during agitation to form large flocs. The flocs thus started to sediment immediately after the turbid water was allowed to stand, and three minutes after that, the turbidity of the supernatant had reached 0 degrees. The two types of flocculants prepared using the grinding processes also formed fine flocs during agitation, and exhibited effects of flocculation.

With these flocculants, however, the rate of sedimentation of flocs was low, and even after 24 hours, the supernatants remained being turbid because unreacted suspended matter remained.

The results of the experiments confirmed that the flocculant of the invention prepared using the dispersion process exhibits a flocculation effect better than those of the flocculants of the comparative examples prepared using the grinding processes.

### Example 3

Examination of the Self-Flocculating Property of the Flocculant in the Water to Be Treated

The flocculant of the invention was examined for the property of flocculating and sedimenting by itself in the water to be treated that is free of suspended matter.

Experimental Procedure

In the experiments, dam lake water with a turbidity of 26 degrees suffering from long-term turbidity was used. This sample turbid water was filtered using a 0.45-μm membrane filter, manufactured by MILLIPORE, and the resulting filtrate with a turbidity of 0 degrees was used as the water to be treated. A 500-ml portion of the water to be treated was poured into each 500-ml beaker, and the beakers were set in a jar tester (JMD-3S, manufactured by Miyamoto Riken Ind. Co., Ltd.). The impeller rotation speed was set to 150 rpm, and 200 mg/L of the flocculant was added to each beaker. After 10 minutes, the impeller rotation speed was set to 50 rpm, and agitation was performed at a low rate for 1 minute. After the operation had stopped, the mixture was allowed to stand, and the state of flocculation was examined.

Experimental Results

2 minutes after the flocculant of the invention was added, small flocs started to form in the water, and after 10 minutes had passed, flocs with an average particle size as large as 3 mm had formed.

The experiments confirmed the self-flocculation property of the flocculant of the invention.

### Example 4

Tests to Confirm Whether or Not the Structure of the Flocculant Is Retained After Shaking Process

A sample of the flocculant of the invention was prepared by dispersing a weathering product of volcanic ash with a pH of 4.5, using a shaking process (for 24 hours in a reciprocating shaker). FIG. 7 shows a transmission electron micrograph of the flocculent.

The micrograph shown in FIG. 7 confirms that unit particles with a particle size of about 5 nm and aggregates of the unit particles are present in the sample of the flocculant of the invention.

The particles of the sample were those of an allophane, which is known to be composed of hollow spherical particles with a diameter of 5 nm. The micrograph shown in FIG. 7 confirms that the structure of the hollow spherical particles was retained.

Therefore, it can be concluded that the structure of the flocculant was not destructed by the dispersion process of the invention.

Tests to Confirm Whether or Not the Structure of the Flocculant Is Destructed by Grinding Process

In order to confirm weather or not allophanes are destructed by comparative dry grinding, two types of allophanes, Kn-P, Ki-P, were ground, and the ground allophanes were subjected to X-ray diffraction analysis. The results are shown in FIG. 8.

In FIG. 8, the uppermost chart shows the result for the untreated allophane, and the lower charts show the results for the allophane which was ground for 1, 2 . . . and 5 minutes.

Since allophanes are much less resistant to grinding than kaolinite, the peaks at 3.3 and 2.5 Å were small for the allophane which was ground for 2 minutes (Henmi, T., Nakai, M., Seki, T. and Yoshinaga, N. 1983. Structural changes of allophanes during dry grinding: Dependence on SiO2/Al203 ratio. Clay Minerals 18, 101-107.).

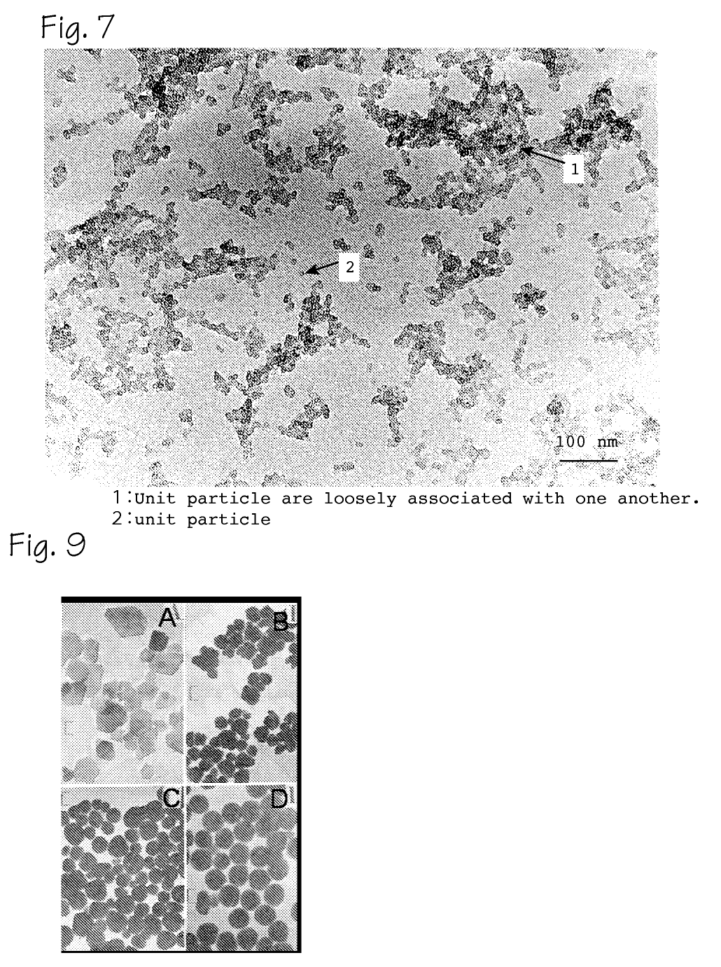

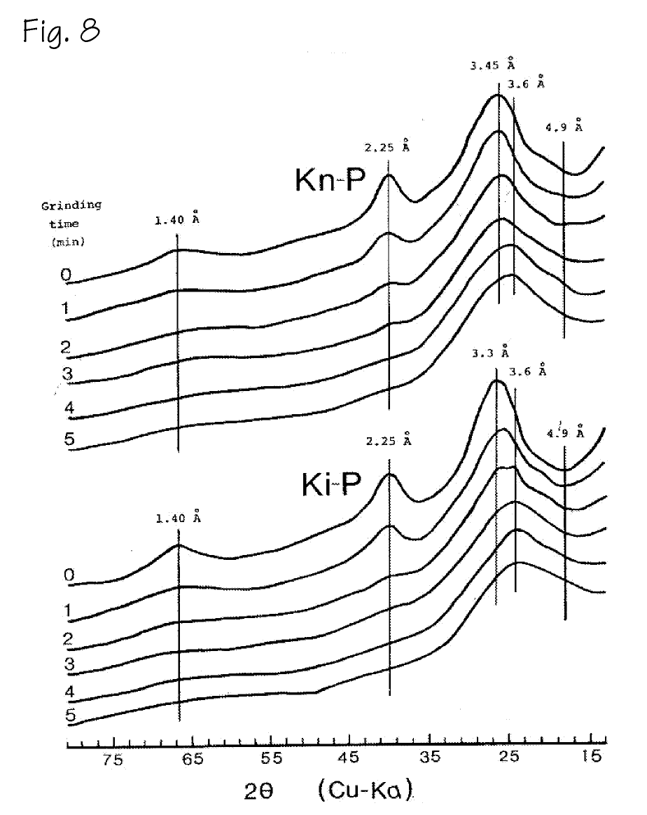

FIGS. 9(A), (B), (C), and (D) show the states of kaolinite destructed by dry grinding. FIG. 9(A) shows the sample raw material, FIG. 9(B) shows the kaolinite after 48 hours of grinding, FIG. 9(C) shows the kaolinite after 96 hours of grinding, and FIG. 9(D) shows the kaolinite after 384 hours of grinding (Nendo (Clay) Handbook, Gihodo, 1967).

The flocculant of the invention can be applied to the treatment of turbid water due to the construction, treatment of sludge at rivers and coasts, eutrophication at ponds and lakes, treatment of large dams and lakes suffering from long-term turbidity, and the like.

What is claimed is:

1. A flocculant comprising, as a principal component, unit particles obtained by breaking down aggregates of mineral particles in a mineral raw material principally comprising fine particles of a hydrous aluminum silicate soils or weathered products of rocks including volcanic eruptives;
the hydrous aluminum silicate in the unit particles retaining a structure thereof;
the unit particles being present in water; and
the unit particles exhibiting a self-flocculating property.

2. The flocculant according to claim 1, wherein the unit particles are dispersed or loosely associated with one another in the water.

3. The flocculant according to claim 2, further comprising a pH adjuster so that the unit particles remain dispersed or loosely associated with one another in the water.

4. The flocculant according to claim 1, wherein the pH or the concentration of a concomitant salt is adjusted so that the unit particles exhibit a self-flocculating property.

5. A method for manufacturing a flocculant, comprising the steps of:
collecting a mineral raw material principally comprising a hydrous aluminum silicate including soils or weathering products of rock including a volcanic eruptives, and sorting the mineral raw material; and
obtaining unit particles by breaking down aggregates of mineral particles in the mineral raw material, using an agitation, vibration or shaking process, with the mineral raw material being admixed with water in a dispersion container;
the step of obtaining the unit particles comprising employing a process selected from the group consisting of agitation, vibration, shaking processes, and a combination thereof, to such an extent that a structure of the hydrous aluminum silicate in the unit particles is not destroyed.

6. The method according to claim 5, further comprising adding a pH adjuster so that the unit particles remain dispersed or loosely associated with one another in the water.

7. The method according to claim 6, wherein the pH or the concentration of a concomitant salt is adjusted so that the unit particles dispersed or loosely associated with one another exhibit a self-flocculating property.
